(19) United States
(12) Patent Application Publication
(10) Pub. No.: US 2015/0120001 A1
(43) Pub. Date: Apr. 30, 2015

(54) DECENTRALIZED PROCESS CONTROLLER

(71) Applicant: Sputtering Components, Inc., Owatonna, MN (US)

(72) Inventors: John Robert German, Owatonna, MN (US); William A. Meredith, JR., Faribault, MN (US); Patrick Lawrence Morse, Tuscon, AZ (US); Brian Rooney, Bloomington, MN (US)

(73) Assignee: Sputtering Components, Inc., Owatonna, MN (US)

(21) Appl. No.: 14/068,267

(22) Filed: Oct. 31, 2013

(51) Int. Cl. G05B 15/02

(52) U.S. Cl. CPC G05B 15/02
USPC 700/19

(57) ABSTRACT

A decentralized process controller comprises at least two programmable interface modules in operative communication with each other. Each of the interface modules includes a processor and is configurable for connection to separate field devices comprising at least one sensor device and at least one actuator device. The at least two programmable interface modules are configurable as a stand-alone process control loop when one of the interface modules is connected to the sensor device, and the other of the interface modules is connected to the actuator device.

### BACKGROUND

Closed-loop feedback control systems are used in industrial applications to hold processes within control limits by monitoring process parameters, by way of various sensors, comparing sensor readings to control limits, and sending corrective signals to control actuators. The sensors can be pressure gauges, thermocouples, optical detectors, strain gauges, flow meters, or potentiometers, for example. The actuators can be electrical power supplies, valves, transistors, piezo crystals, or mass flow controllers, as examples. Sensors and actuators will henceforth be collectively referred to as “field devices.”

Typical architecture for such control systems has a central computer that collects process information by a plurality of sensors, runs comparator algorithms, such as proportional-integral-derivative (PID) loops, and sends output signals to a plurality of actuators. The inputs and outputs, collectively called I/O, can be analog or digital.

In some processes, it is necessary that the control systems have a very fast response time. An example of this is in reactive sputtering deposition processes, with which a large variety of functional films are formed. Frequently, the most desirable mode of operation in reactive sputtering processes is in a process space that exhibits instability. It is within the unstable part of the process space that the most desirable balance of deposition rate and film properties is achieved. In order to hold a process in the optimum process space, the control system often needs to have an update time of a couple hundred or even a few tens of milliseconds.

Typical dedicated after-market systems that are retro-fitted into existing equipment have a fixed and limited number of I/O channels, which can limit the system's usefulness and flexibility. Such systems also tend to be very expensive. This is due, in part, to the fixed number of channels. The user pays for all channels, even if fewer channels are needed than what the system provides. Likewise, if more channels are needed, additional system devices must be purchased that also may have more channels than required.

Another limiting factor of many process controllers is that they have central processors, which does all the data processing for multiple channels. This can cause undesirably slow updates due to I/O traffic management issues that can arise. Moreover, another entire multi-channel controller module must be kept in inventory in case any single channel fails. Additional inconvenience is suffered, using such systems, due to a frequent requirement to run very long analog signal wire or fiber optic cables. Long optical fibers also come at considerable expense.

In a more recent system, Ethernet-based interface modules are disposed between a central computer and field devices. The modules communicate via Ethernet to the central computer and are adapted to also communicate with one or more of the field devices. In one commercially available process monitoring system, which includes an Ethernet card with a Power over Ethernet option, an on-board microprocessor allows the system to act as a stand-alone monitoring unit. This system can also link, via Ethernet, with a central computer for remote monitoring and device setting adjustments.

Although some limitations of common process control systems have been reduced in the more recent systems, other limitations remain. One limitation is from the network, wherein data transfer through the hub may not be fast enough for all process control requirements, such as for reactive sputtering as described previously. Data transfer restrictions are usually due to latencies, rather than transfer rates. Jitter or inconsistency of data packet times can reduce the capacity of a fast control loop to be effective. Another limitation is that the system still relies on a single central processor to perform all necessary calculations for a plurality of control loops. This requires that the central processor is properly sized for the work load. In addition, the central processor is necessary for redundancy in case of computer failure.

### SUMMARY

A decentralized process controller is provided that comprises at least two programmable interface modules in operative communication with each other. Each of the interface modules includes a processor and is configurable for connection to separate field devices comprising at least one sensor device and at least one actuator device. The at least two programmable interface modules are configurable as a stand-alone process control loop when one of the interface modules is connected to the sensor device, and the other of the interface modules is connected to the actuator device.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of a decentralized control system according to one embodiment.

### DETAILED DESCRIPTION

This disclosure relates to closed-loop feedback process control systems. In particular, a decentralized process controller is provided that comprises a number of stand-alone interface modules that each contains an onboard microprocessor, a component for interfacing with field devices, and a digital communications unit. The process controller can optionally supply power and communication over the same cable, such as by the Power-over-Ethernet (PoE) protocol in an embodiment using Ethernet for communications. When the process controller is connected to field devices, the process controller becomes part of a decentralized process control system.

The microprocessor is programmable such that it can perform pre-processing of information from a sensor device, before sending a data packet over the communication network. Alternately, the microprocessor can be programmed so that data received over the communication network can be processed, as by a comparator algorithm, such as a PID loop, before sending a control signal to an actuator device. Interfacing with field devices can be done via pass-through cable connectors. Various interchangeable cables can be provided to facilitate connecting the interface modules to a variety of field devices. Such an interchangeable cable has a pass-through connector, adapted to a particular field device, on one end. The other end of the cable has a common connector, such as a universal serial bus (USB), D-sub connector, or the like, depending on required signals that connect to the interface modules.

A feedback control loop includes any two interface modules, one connected to a sensor device and the other connected to an actuator device. Each module can interface with any variety of commercially available field devices by way of the pass-through cable connectors. Each interface module performs relatively simple operations dedicated to its particular control loop.

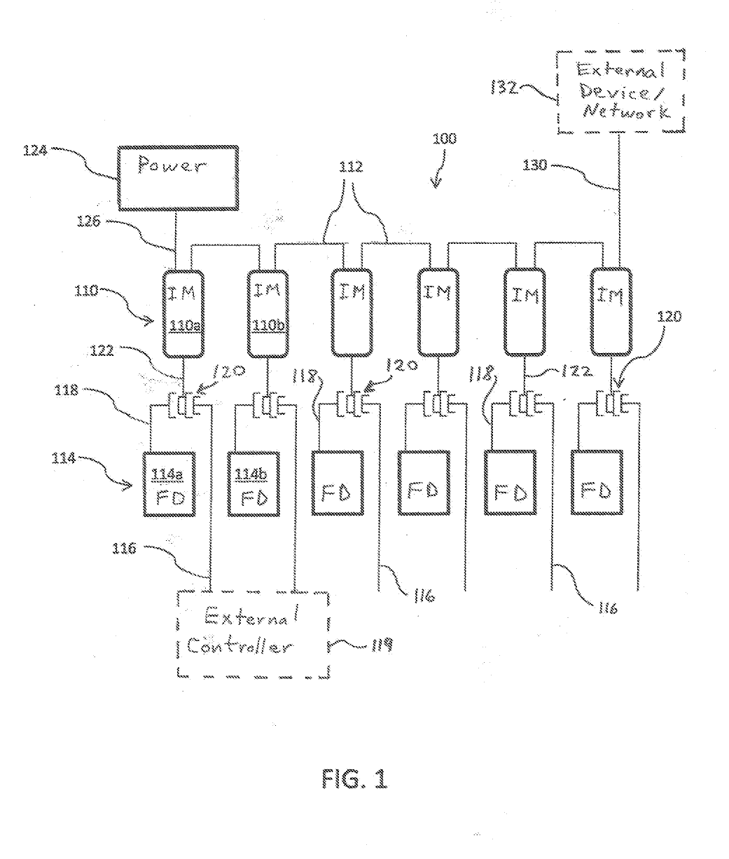

Referring to FIG. 1, a decentralized process control system 100 is depicted according to one embodiment. The process control system 100 includes a plurality of programmable interface modules (IM) 110 in operative communication with each other, such as through a set of digital communications cables 112. Alternatively, the interface modules 110 can communicate with each other through a wireless communications connection. Each of interface modules 110 includes a processor, and is configurable for connection to one or more field devices (FD) 114. The field devices 114 can be sensor devices, actuator devices, or the like.

In one exemplary implementation, a first interface module 110a is operatively connected to a first field device 114a that is a sensor device, and a second interface module 110b is operatively connected to a second field device 114b that is an actuator device. In this implementation, the first and second interface modules 110a and 110b are configurable as a stand-alone process control loop.

A set of cables 116, 118 provide communication between a main processing operating system such as an external controller 119 and each of field devices 114. A pass-through connector 120 is connected between connector plugs at the ends of each of cables 116, 118 to allow transmission of data between field devices 114 and interface modules 110 via respective interface cables 122.

A power supply (or communication master) 124 can provide power to interface modules 110 through a power cable 126. Alternately, a PoE Ethernet hub may be used in place of the power supply. A connection cable 130 provides communication between process control system 100 and an external device or network 132. In the embodiment where a PoE Ethernet hub is used as a power supply, cable 130 can optionally extend from the hub rather than from one of the interface modules. An outside link to the external device or external network can be made by a wired link, or through a wireless link such as by using a wireless router. External devices may include a personal computer, or a mobile device such as a tablet computer or a smart phone.

In one embodiment, the interface modules have at least two serial communication ports so that devices can be connected in series or parallel. A plurality of interface modules, thus connected, forms a communications network. This embodiment can use a custom communications protocol because of its potential to be more efficient, streamlined, and easier to implement than some commercially available protocols. Commercial protocols tend to be designed to accommodate a large variety of devices, making them unduly complicated. Moreover, hardware related to commercial protocols can be excessively expensive.

Embodiments that comprise Ethernet communications can use the EtherCAT (Ethernet for Control Automation Technology) protocol, which does not require an Ethernet hub. The EtherCAT protocol is designed to provide lower and more deterministic data transfer latency. An Ethernet hub does, however, remain optional.

The primary purpose of linking the process control system to an external computer is to provide a human-machine-interface (HMI) to allow for process monitoring or interface module programming. For example, a user can assign Ethernet addresses and duties to each of the interface modules using the HMI. The link can also be useful to monitor the behavior of the processes or the functioning of the interface module. The connection to the external computer is not essential to the operation of the control algorithms. Hence, the external computer is not a source of catastrophic failure of the control system, as can be the case in most standard control architectures.

The function of an interface module connected to a sensor is to receive process parameter information from the sensor, perform relatively simple data processing, digitize the resulting information, and transmit an information data packet into the communication network. The data processing may include averaging, peak detection, smoothing, or any other useful function that converts raw data into a more useful form. Interface modules connected to actuator devices will monitor the serial data stream, select the relevant data from that stream, compare the data to a set-point, and transmit an appropriate control signal to the actuation device. Because the microprocessor in each module is dedicated to a single, simple function, a low-powered, inexpensive processor can be used. The use of simple and inexpensive processors is not compatible with commercially available field bus communication protocols. Hence, a custom protocol can be employed as previously mentioned when using simple processors.

A conflict may arise when the interface module is connected to an actuator field device on an existing system. Normally, the actuator field device already receives a control signal from an external controller such as a Programmable Logic Controller (PLC). Adding the connection from the interface module adds a second control signal. There are a variety of possible methods to resolve this conflict. The pass-through connector on the interface cable can be designed to re-route the PLC signal into the interface module, where an option is available to use either the PLC signal or the signal from the interface module of the process controller. Alternately, a switching mechanism, such as a relay or solid state switch, can be built into the interface cable's pass-through connector. The switching mechanism can be activated, by either the PLC or the interface module, to choose which control signal is transmitted to the actuator device. In another alternative, a manual switch can be employed.

One advantage of the present system is its flexibility. One common interface module can be adapted to interface with either sensor or actuator devices. Hence, the user needs to purchase only enough channels for the job at hand and a very low inventory of back-up modules can be kept in stock. Additionally, less cabling is needed because Ethernet cables run from device to device instead of having a cable from each device back to a central hub. Further, the use of pass-through connectors to interface with field devices makes it easy to retrofit the control system to a wide variety of existing equipment as an upgrade. Any interface module can be reset and moved to any other field device. Another advantage of the present system is its increased speed, as data transfer between interface modules is not hampered by traffic management through a central Ethernet hub or a central computer.

A further benefit of the present system is low cost. Due to the simplicity of the system requirements, each interface module can be assembled from inexpensive, commercially available components. Furthermore the user needs only to purchase what is needed for the job. Also, due to the versatility of the interface modules, a very limited inventory is required for replacement components.

Another benefit of the present control system is that it is decentralized and does not require a dedicated central computer. Any two interface modules can constitute a stand-alone process control loop, once set up to act as such. Yet, the interface modules can be accessed through any capable computer device, directly or remotely, for the purpose of monitoring or adjusting interface module function.

### EXAMPLE EMBODIMENTS

Example 1 includes a decentralized process controller, comprising: at least two programmable interface modules in operative communication with each other, each of the interface modules including a processor and configurable for connection to separate field devices, the field devices comprising at least one sensor device and at least one actuator device; wherein the at least two programmable interface modules are configurable as a stand-alone process control loop when one of the interface modules is connected to the sensor device, and the other of the interface modules is connected to the actuator device.

Example 2 includes the controller of Example 1, wherein the interface modules are in operative communication with each other by a digital communications cable or a wireless communications connection.

Example 3 includes the controller of any of Examples 1-2, wherein the interface modules are connected to each other via an Ethernet connection.

Example 4 includes the controller of any of Examples 2-3, wherein power to the interface modules is transmitted over the digital communications cable from a power supply.

Example 5 includes the controller of Example 3, wherein the Ethernet connection provides a power over Ethernet protocol.

Example 6 includes the controller of any of Examples 3-5, wherein the Ethernet connection provides an EtherCAT protocol.

Example 7 includes the controller of any of Examples 1-6, wherein the interface modules are accessible by a human-machine-interface for process monitoring or interface module programming.

Example 8 includes the controller of any of Examples 1-7, wherein each of the interface modules are connected to the field devices via pass-through connectors on the ends of respective cables opposite to each cable's connection to one of the interface modules.

Example 9 includes the controller of Example 8, wherein the cables with the pass-through connectors are interchangeable by having common connectors on the ends of the cables connected to the interface modules.

Example 10 includes a decentralized process control system comprising: a plurality of programmable interface modules in operative communication with each other, each of the interface modules including a processor; and a plurality of field devices, each of the field devices removably connected and in communication with a respective interface module, the field devices comprising at least one sensor device and at least one actuator device. A first interface module of the programmable interface modules is operatively connected to one of the field devices that is a sensor device, and a second interface module of the programmable interface modules is operatively connected to another one of the field devices that is an actuator device.

Example 11 includes the control system of Example 10, wherein the first and second interface modules are configured as a stand-alone process control loop without a central computer.

Example 12 includes the control system of any of Examples 10-11, wherein the interface modules communicate with each other via an Ethernet connection or a wireless communications connection.

Example 13 includes the control system of any of Examples 10-12, further comprising a power source coupled to the interface modules.

Example 14 includes the control system of Example 13, wherein the power source comprises a power over Ethernet hub.

Example 15 includes the control system of any of Examples 10-14, wherein the field devices are removably connected to the interface modules with pass-through connectors.

Example 16 includes the control system of Example 15, wherein control signals for the actuator devices are selected and sourced from the interface modules or from an external controller coupled to the pass-through connectors.

Example 17 includes the control system of any of Examples 10-16, wherein the interface modules are in operative communication with an external device or an external network.

Example 18 includes the control system of Example 17, wherein the external device comprises a personal computer, a tablet computer, or a smart phone.

Example 19 includes the control system of any of Examples 17-18, wherein the interface modules communicate with the external device or external network through a wireless link.

Example 20 includes the control system of any of Examples 11-19, wherein the first interface module is configured to: receive process parameter information from the sensor; perform data processing of the information; digitize the processed information; and transmit an information data packet to a communication network; and wherein the second interface module is configured to: monitor a serial data stream from the actuator device; select relevant data from the serial data stream; compare the relevant data to a set-point; and transmit an appropriate control signal to the actuation device.

While a number of embodiments have been described, it will be understood that the described embodiments are to be considered only as illustrative and not restrictive, and that various modifications to the described embodiments may be made without departing from the scope of the invention. The scope of the invention is therefore indicated by the appended claims rather than by the foregoing description. All changes that come within the meaning and range of equivalency of the claims are to be embraced within their scope.

What is claimed is:

1. A decentralized process controller, comprising:
at least two programmable interface modules in operative communication with each other, each of the interface modules including a processor and configurable for connection to separate field devices, the field devices comprising at least one sensor device and at least one actuator device;
wherein the at least two programmable interface modules are configurable as a stand-alone process control loop when one of the interface modules is connected to the sensor device, and the other of the interface modules is connected to the actuator device.

2. The controller of claim 1, wherein the interface modules are in operative communication with each other by a digital communications cable or a wireless communications connection.

3. The controller of claim 1, wherein the interface modules are connected to each other via an Ethernet connection.

4. The controller of claim 2, wherein power to the interface modules is transmitted over the digital communications cable from a power supply.

5. The controller of claim 3, wherein the Ethernet connection provides a power over Ethernet protocol.

6. The controller of claim 3, wherein the Ethernet connection provides an EtherCAT protocol.

7. The controller of claim 1, wherein the interface modules are accessible by a human-machine-interface for process monitoring or interface module programming.

8. The controller of claim 1, wherein each of the interface modules are connected to the field devices via pass-through connectors on the ends of respective cables opposite to each cable's connection to one of the interface modules.

9. The controller of claim 8, wherein the cables with the pass-through connectors are interchangeable by having common connectors on the ends of the cables connected to the interface modules.

10. A decentralized process control system comprising:
a plurality of programmable interface modules in operative communication with each other, each of the interface modules including a processor; and
a plurality of field devices, each of the field devices removably connected and in communication with a respective interface module, the field devices comprising at least one sensor device and at least one actuator device;
wherein a first interface module of the programmable interface modules is operatively connected to one of the field devices that is a sensor device, and a second interface module of the programmable interface modules is operatively connected to another one of the field devices that is an actuator device.

11. The control system of claim 10, wherein the first and second interface modules are configured as a stand-alone process control loop without a central computer.

12. The control system of claim 10, wherein the interface modules communicate with each other via an Ethernet connection or a wireless communications connection.

13. The control system of claim 12, further comprising a power source coupled to the interface modules.

14. The control system of claim 13, wherein the power source comprises a power over Ethernet hub.

15. The control system of claim 10, wherein the field devices are removably connected to the interface modules with pass-through connectors.

16. The control system of claim 15, wherein control signals for the actuator devices are selected and sourced from the interface modules or from an external controller coupled to the pass-through connectors.

17. The control system of claim 10, wherein the interface modules are in operative communication with an external device or an external network.

18. The control system of claim 17, wherein the external device comprises a personal computer, a tablet computer, or a smart phone.

19. The control system of claim 17, wherein the interface modules communicate with the external device or external network through a wireless link.

20. The control system of claim 11, wherein the first interface module is configured to:
receive process parameter information from the sensor;
perform data processing of the information;
digitize the processed information; and
transmit an information data packet to a communication network; and
wherein the second interface module is configured to:
monitor a serial data stream from the actuator device;
select relevant data from the serial data stream;
compare the relevant data to a set-point; and
transmit an appropriate control signal to the actuation device.
